(19) United States
(12) Patent Application Publication
(10) Pub. No.: US 2003/0026253 A1
(43) Pub. Date: Feb. 6, 2003

(54) Method and terminal for multipoint communication

(75) Inventors: Manfred Burger, Miesbach (DE); Thomas Lederer, Muenchen (DE); Hubertus Hohl, Haar (DE)

Correspondence Address: STAAS & HALSEY LLP, 700 11TH STREET, NW, SUITE 500, WASHINGTON, DC, 20001, US

(73) Assignee: Siemens AG.

(21) Appl. No.: 10/210,875

(22) Filed: Aug. 2, 2002

(30) Foreign Application Priority Data
Aug. 3, 2001 (DE) 101 382 67.7

(51) Int. Cl. H04L 12/28; H04J 3/26

(52) U.S. Cl. 370/390; 370/432

(57) ABSTRACT

Communication data streams are transmitted within the scope of a multipoint connection from a first terminal to other terminals. The first terminal distributes communication data streams originating at the first terminal and received from the other terminals involved in the multipoint connection. As a result, each of the other terminals receives the communication data streams originating from the other terminals.

### CROSS REFERENCE TO RELATED APPLICATIONS

This application is based on and hereby claims priority to German Application No. 101 382 67.7 filed on Aug. 3, 2001, the contents of which are hereby incorporated by reference.

### BACKGROUND OF THE INVENTION

Contemporary communication systems support not only two-point connections but generally also multipoint connections, i.e. connections between three or more subscribers. Such multipoint connections can, by way of example, be set up between terminals for voice, video or multimedia communication or between personal computers to set up voice, video or multimedia conference calls, for example.

Within the scope of such a conference call, the conferees' terminals can be regarded as a source for communication data streams, such as voice, video or multimedia data streams. To set up the conference call, each conferee needs to be sent all the communication data streams from the other conferees involved. In the case of a conference call involving N conferees, N* unidirectional communication data streams thus need to be set up and to be transmitted in co-ordinated fashion. With direct transmission of all the communication data streams from all the conferees to all the other conferees, however, the co-ordination complexity required for this and the transmission bandwidths required increase sharply as the number of conferees increases.

To avoid this high level of co-ordination complexity, modern packet-oriented communication networks use “conference servers” as central control units in the communication network. Such a conference server receives the communication data streams sent by the conferees' terminals centrally and distributes them to the individual conferees' terminals. When setting up a conference call using a conference server, the conferees dial up the conference server individually and are added to the conference call by the conference server. Such conference servers are known, by way of example, from section 6.8 of ITU-T recommendation H.323.

However, using a conference server requires a high level of additional hardware and software complexity. In particular, additional management complexity is required for the conferees' terminals, e.g. for logging on and logging off with the conference server and for reserving transmission resources on the conference server. In addition, this type of conference setup requires the conferees to agree on a conference time in advance. This is also generally very time-consuming.

### SUMMARY OF THE INVENTION

It is an object of the present invention to specify a less complex multipoint communication method.

It is furthermore an object of the invention to specify a terminal for implementing the method.

On the basis of the invention, communication data streams to be transmitted within the scope of a multipoint connection, such as voice, video or multimedia data streams, are distributed locally by a first terminal involved in the multipoint connection to other terminals involved in the multipoint connection. The terminals involved in the multipoint connection can, by way of example, be terminal equipment, such as voice telephones, videophones, or personal computers or application programs or client applications running thereon.

A fundamental advantage of the invention is that setting up a multipoint connection requires no additional central control unit, such as a conference server. In addition, the invention results in lower network loading and in a lower level of co-ordination complexity for setting up a multipoint connection, since, in particular, no additional connection to a central conference server and no reservation of transmission resources on this conference server are required. The inventive method can thus be used, in particular, for setting up an “ad-hoc conference” from a “peer-to-peer” call situation very flexibly and inexpensively.

The subscribers on the other terminals encounter no additional management complexity. In addition, none of the other terminals need to have a specific conference functionality implemented, such as logging on and logging off with a conference server. A multipoint connection can also easily be managed dynamically from the first terminal, e.g. by adding further subscribers or by logging off subscribers, without the need for any specific reaction from the other terminals.

In accordance with one advantageous embodiment of the invention, the multipoint connection can be initiated by the first terminal by setting up two-point connections, which can be circuit-switched or packet-switched, to the other terminals. The two-point connections which have been set up are used to transmit the communication data streams. Central initiation of the multipoint connection by the subscriber on the first terminal simplifies further management of the multipoint connection considerably.

In accordance with one embodiment of the invention, the communication data streams to be transmitted from the first terminal to one of the other terminals can be transmitted together via a common two-point connection between the first terminal and the other terminal in question. For transmission via a common two-point connection, the communication data streams in question can be combined in the first terminal, e.g. by multiplexing, to form a separate data stream. Another terminal receiving this composed data stream can reseparate the communication data streams which the composed data stream contains, e.g. by demultiplexing, and can condition them for local, separate output. Transmission of the communication data streams via a common two-point connection has the advantage that the other terminal in question needs to manage a total of just two unidirectional two-point connections or one bidirectional two-point connection.

In accordance with another embodiment of the invention, the communication data streams to be transmitted from the first terminal to another terminal can be transmitted via separate two-point connections between the first terminal and the second terminal. Separating the individual communication data streams to be transmitted into separate two-point connections has the advantage that the complexity for combining the communication data streams using the first terminal and for separating the communication data streams using the other terminals in question can be eliminated.

Advantageously, the two-point connections can be set up in the form of “peer-to-peer” connections, i.e. two-point connections between connection parties which have equal rights with respect to the connection.

In accordance with one advantageous development of the invention, within the scope of reception of the communication data streams by the first terminal, the communication data stream originating from the first terminal itself can also be received logically by the first terminal. The first communication device thus receives—at least logically—the communication data streams originating from all the terminals involved in the multipoint connection. In addition, within the scope of transmission of the communication data streams by the first terminal, the communication data streams originating from the further communication devices can be transmitted logically to the first communication device. The communication data streams transmitted by the first terminal are thus transmitted—at least logically—to all the terminals involved in the multipoint connection. These additional, logical transmissions simplify the logic organization and co-ordination of the transmission of the communication data streams considerably.

In accordance with another advantageous embodiment of the invention, the communication data streams can be transmitted via a packet-oriented communication network. In particular, this can involve the use of transfer protocols from the “TCP/IP” protocol family.

The invention can be applied particularly advantageously to video conference calls where moving picture streams need to be transmitted in real time. Given the high data transfer rates required for this, the invention's achievable reduction in management complexity and in network loading is particularly beneficial.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIGS. 1 and 2 are block diagrams, each showing three terminals when communication data streams are being interchanged within the scope of a conference call, and

FIG. 3 is a block diagram of a terminal in accordance with the invention.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

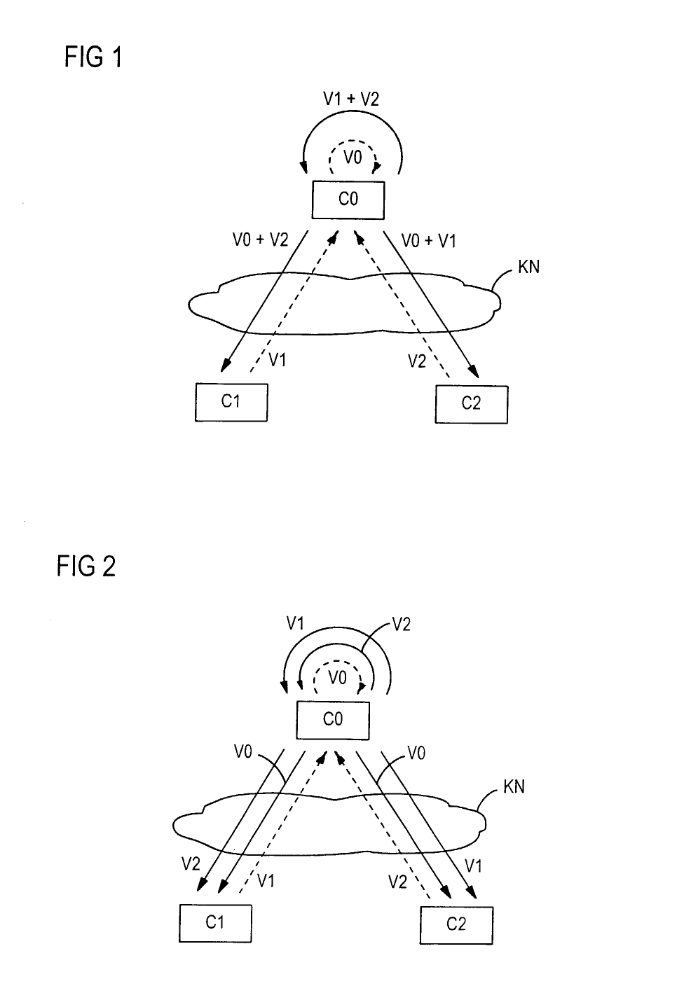

FIGS. 1 and 2 each show three terminals C0, C1 and C2 coupled via a communication network KN, e.g. for voice, video or multimedia communication, in schematic form. For the present exemplary embodiment, it will be assumed that the terminals C0, C1 and C2 are in the form of client applications, called clients below for short, which have video capability and run on a personal computer. The communication network KN is preferably in the form of a packet-switched communication network whose transfer protocols are based on the TCP/IP protocol family.

The clients C0, C1 and C2 are connected to one another within the scope of a multipoint connection which is in the form of a video conference call in the present exemplary embodiment.

Setup of the video conference call is initiated by the client C0. To this end, the client C0 progressively sets up two-point connections, preferably “peer-to-peer” connections, to the terminals of all the other conferees, in this case to the clients C1 and C2, via the communication network KN. The two-point connections can be set up, by way of example, by dialing up the clients C1 and C2 using a call number.

When the two-point connection from the client C0 to the client C1 has been set up, the latter transmits, within the scope of the video conference call, a communication data stream in the form of a video data stream V1 to the client C0 via the two-point connection which has been set up. Correspondingly, when the two-point connection from the client C0 to the client C2 has been set up, the client C2 transmits a communication data stream in the form of a video data stream V2 to the client C0 via this two-point connection. In addition, the client C0 receives a video data stream V0 from its own video input/output IO. The video data streams V0, V1 and V2 respectively received by the client C0 are illustrated in the figures by dashed arrows.

Following reception of the video data streams V0, V1 and V2, all the video data streams to be distributed within the scope of the video conference call are available in the client C0. The client C0 now allocates to each client C0, C1 and C2 involved in the video conference call the video data streams originating from each of the other clients. In the present exemplary embodiment, the video data streams V0 and V2 are thus allocated to the client C0, the video data streams V0 and V1 are allocated to the client C2, and the video data streams V1 and V2 are allocated to the client C0. The client C0 then transmits the video data streams allocated to a respective client, in this case C0, C1 and C2, to this respective client.

The video data streams allocated to a client can be transmitted to this client in various ways: A first method variant is illustrated by FIG. 1. In this case, the video data streams to be transmitted to a respective client C0, C1 or C2 are transmitted, at least logically, within a common two-point connection. The respective two-point connections and the respective transmission direction are illustrated in FIG. 1 by solid arrows. To transmit a plurality of video data streams via a common two-point connection, the video data streams in question are combined in the transmitter, in this case C0, and are reseparated at the respective receiver, in this case C0, C1 or C2, where they are conditioned for separate display. In this context, the video data streams can be combined by mixing or multiplexing, for example, and can be reseparated by demultiplexing.

A second method variant for transmitting the video data streams using the client C0 is illustrated by FIG. 2. In this context, each video data stream to be transmitted to a client C0, C1 or C2 is transmitted, at least logically, to the receiver client C0, C1 or C2 in question via a separate two-point connection. In the present exemplary embodiment, this requires the client C0 to set up, at least logically, two separate two-point connections to each receiver client C0, C1 or C2. In FIG. 2, these two-point connections and the respective transmission direction are indicated by solid arrows. The use of separate two-point connections has the advantage that combination of video data streams by the client C0 and separation of these video data streams at the respective receiver client C0, C1 or C2 can be dispensed with.

The two-point connections to be set up in order to transmit the video data streams are preferably in the form of peer-to-peer connections.

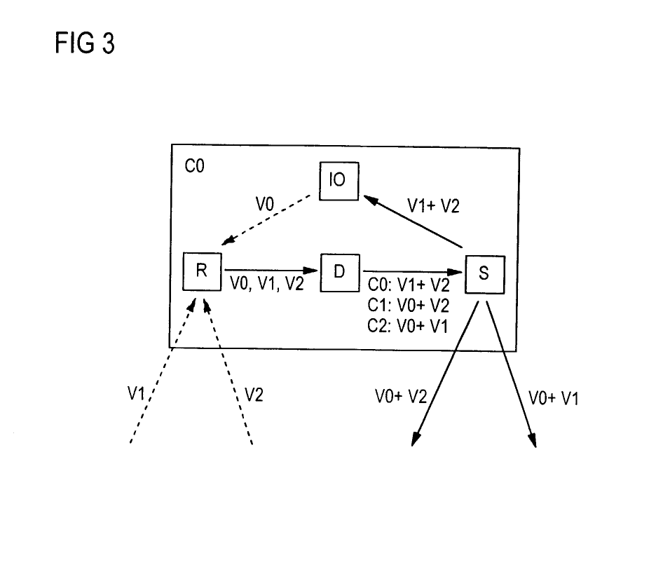

FIG. 3 shows a block diagram of the inventive client C0. As functional components, the client C0 contains a video input/output IO, a data reception device R, a data distribution device D and a data transmission device S. The video input/output IO forms a video data source and a video data sink. The indicated functional components can be produced using software modules, for example. The data reception device R receives—as indicated by dashed arrows—the video data stream V1 from the client C1, the video data stream V2 from the client C2, and the video data stream V0 from the client's C0 own video input/output IO. The received video data streams V0, V1 and V2 are transmitted from the data reception device R to the data distribution device D. The data distribution device D allocates to each of the clients C0, C1 and C2 the video data streams originating from each of the other clients. In the present exemplary embodiment, the video data streams V1 and V2 are thus allocated to the client C0, the video data streams V0 and V2 are allocated to the client C1, and the video data streams V0 and V1 are allocated to the client C2. The video data streams and their associations are transmitted from the data distribution device D to the data transmission device S. The latter transmits the video data streams allocated to a respective client C0, C1 or C2 to this client, at least logically. That is to say that, in the present exemplary embodiment, the data transmission device S transmits the video data streams V0 and V2 to the client C1, transmits the video data streams V0 and V1 to the client C2, and transmits the video data streams V1 and V2 to the client's C0 own video input/output IO.

The inventive client C0 and the indicated method variants can be implemented efficiently with little complexity, since popular architectures for video integration on the basis of the TCP/IP protocol family support mixing of video data streams and setup of peer-to-peer video links by provided application interfaces, such as the “Java Media Framework” from Sun Microsystems.

The local control of the conference call and the distribution of the communication data streams V0, V1, V2 by a terminal involved in the conference call, in this case C0, mean that the invention can be implemented very flexibly and inexpensively in existing communication systems.

The invention has been described in detail with particular reference to preferred embodiments thereof and examples, but it will be understood that variations and modifications can be effected within the spirit and scope of the invention.

What is claimed is:

1. A method for distributing communication data streams via a multipoint connection between a first terminal and other terminals, comprising:
receiving remote communication data streams from the other terminals at the first terminal, and
transmitting from the first terminal, the remote communication data streams and a first terminal communication data stream originating from the first terminal to each of the other terminals, so that each receiving terminal receives the first terminal communication data stream and any of the remote communication data streams not originating at the receiving terminal.

2. The method as claimed in claim 1,
further comprising initiating the multipoint connection by the first terminal by setting up two-point connections from the first terminal to the other terminals, and
wherein said receiving and transmitting use the two-point connections.

3. The method as claimed in claim 2, wherein the remote and first terminal communication data streams transmitted from the first terminal to at least one of the other terminals are transmitted together one of the two-point connections.

4. The method as claimed in claim 2, wherein the remote and first terminal communication data streams transmitted from the first terminal to at least one of the other terminals are transmitted via separate two-point connections.

5. The method as claimed in claim 4, wherein said initiating sets up the two-point connections as peer-to-peer connections.

6. The method as claimed in claim 5, wherein the first terminal communication data stream logically is received by the first terminal equivalently to said receiving of the remote communication data streams.

7. The method as claimed in claim 6, further comprising logically transmitting the remote communication data streams from the other terminals in a manner equivalent to said transmitting of the remote and first terminal communication data streams from the first communication device.

8. The method as claimed in claim 7, wherein the remote and first terminal communication data streams are transmitted via a packet-oriented communication network

9. The method as claimed in claim 8,
wherein the multipoint connection is a video conference call, and
wherein the remote and first terminal communication data streams are video data streams.

10. The method as claimed in claim 3, wherein said initiating sets up the two-point connections as peer-to-peer connections.

11. The method as claimed in claim 10, wherein the first terminal communication data stream logically is received by the first terminal equivalently to said receiving of the remote communication data streams.

12. The method as claimed in claim 11, further comprising logically transmitting the remote communication data streams from the other terminals in a manner equivalent to said transmitting of the remote and first terminal communication data streams from the first communication device.

13. The method as claimed in claim 12, wherein the remote and first terminal communication data streams are transmitted via a packet-oriented communication network

14. The method as claimed in claim 13,
wherein the multipoint connection is a video conference call, and
wherein the remote and first terminal communication data streams are video data streams.

15. A terminal for distributing communication data streams via a multipoint connection between said terminal and other terminals, comprising:
a data reception device to receive remote communication data streams from the other terminals,
a data distribution device, coupled to said data reception device, for allocation of the remote communication data streams and a local communication data stream originating from said terminal, to the other terminals, so that each receiving terminal is allocated the local communication data stream and any of the remote communication data streams not originating at the receiving terminal, and
a data transmission device, coupled to said data distribution device, to transmit the local and remote communication data streams to the other terminals in accordance with the allocation by said data distribution device.
